(19) United States
(12) Patent Application Publication
(10) Pub. No.: US 2023/0337703 A1
(43) Pub. Date: Oct. 26, 2023

(54) TEA-BASED COMPOSITIONS FOR OXYGEN MODIFIED PACKAGING

(71) Applicant: CSP Technologies, Inc., Auburn, AL (US)

(72) Inventors: Jason Pratt, Auburn, AL (US); Kathryn Perko, Auburn, AL (US)

(21) Appl. No.: 17/905,741

(22) PCT Filed: Mar. 5, 2021
(86) PCT No.: PCT/US21/70240

§ 371 Date: Sep. 6, 2022

Related U.S. Application Data
(60) Provisional application No. 62/986,294, filed on Mar. 6, 2020.

(51) Int. Cl. A23L 3/3472; B01J 20/28; B01J 20/22; B65D 81/26

(52) U.S. Cl. CPC A23L 3/3472; B01J 20/2805; B01J 20/22; B01J 20/28035; B01J 20/28026; B65D 81/268; B01J 2220/44

(57) ABSTRACT

Disclosed are compositions comprising tea-based oxygen scavenging active agents polymer compositions, including polymer compositions, materials, and containers that incorporate such agents from the Camellia sinensis plant for use in packaging and storing of oxygen sensitive products. Such compositions, materials and containers are of use for preserving the shelf-life of products such as foods, pharmaceuticals, cosmetics, tobacco and cannabis.

### CROSS-REFERENCE TO RELATED APPLICATIONS

This application claims priority to U.S. Provisional Patent Application No. 62/986,294, entitled “TEA-BASED COMPOSITIONS FOR OXYGEN MODIFIED PACKAGING,” filed on Mar. 6, 2020, the contents of which are incorporated herein by reference in their entirety.

### FIELD OF INVENTION

The present invention relates to packaging and methods of using oxygen scavenging materials to reduce oxygen levels and maintain product properties of packaged oxygen sensitive products. Specifically, the oxygen scavenging materials and methods of the invention comprise the step of incorporating tea into a material or container used to package oxygen sensitive objects typically in order to increase the shelf life or otherwise improve the quality of the product packaged therein.

### BACKGROUND

It is well known that regulating the exposure of oxygen sensitive products maintains and enhances the quality, flavor and stability or shelf life of the product. In packaging oxygen sensitive materials such as foodstuffs, beverages, and pharmaceuticals, oxygen contamination can be particularly troublesome. Care is generally taken to reduce the detrimental or undesirable effects of oxygen on the product. Many food products suffer oxygen-initiated degradation; for example, individual portions of prepared foods are marketed in containers made of plastics, and air entrapped therein, and leaking or transferring into the package after processing, is an acknowledged industry problem.

Oxygen sensitive products include a variety of products such as foods, herbs, beverages, pharmaceuticals, cosmetics, tobacco and more recently, cannabis products. Electronic components may also be sensitive to moisture or atmospheric oxygen and require special packaging. Oxygen scavengers are also used in sealed storage of military products such as missile components and ammunition.

In the food and beverage packaging industry, limiting the exposure of oxygen sensitive food products to oxygen in a packaging system maintains the quality or freshness of the food, reduces spoilage, and extends the food's shelf life. For example, antioxidants (such as sulfur dioxide, trihydroxy butyrophenone, butylated hydroxy toluene and butylated hydroxy anisole) and oxygen scavengers (such as ascorbic acid, isoascorbic acid and glucose oxidase-catalase) have been used as chemical additives in an attempt to reduce the effects of oxygen contamination on beer (See e.g., Reinke et al., “Effect of Antioxidants and Oxygen Scavengers on the Shelf-life of Canned Beer,” A.S.B.C. Proceedings, 1963, pp. 175-180, Thomson, “Practical Control of Air in Beer”, Brewer's Guild Journal, Vol. 38, No. 451, May 1952, pp. 167-184, and von Hodenberg, “Removal of Oxygen from Brewing Liquor,” Brauwelt International, III, 1988, pp. 243-4). The direct addition of such agents into beer has several disadvantages. Both sulfur dioxide and ascorbates, when added to beer, can result in production of off-flavors thus negating the intended purpose of the addition.

Numerous means for regulating oxygen exposure within packaging containers have been developed. Methods for excluding oxygen have involved mechanical means, including vacuum and inert gas packaging. In these procedures, the oxygen is removed by displacement of the entire atmospheric mixture in the package by vacuumizing or flushing the oxygen from the container. In some instances, the package is backfilled with an inert gas. Such systems are used in boiler water treatment, the orange juice and brewing industries, and in modified-atmosphere packaging of food products. This technology, while somewhat equipment intensive, can remove about 90-95% of the oxygen present in air from the product (or its container) prior to or during packaging. However, the removal of the remaining 5-10% of oxygen using this approach requires longer times for vacuum treatment and increasingly larger volumes of higher and higher purity inert gas which must not itself be contaminated with trace levels of oxygen. This makes the removal by such methods of the last traces of oxygen expensive. A further disadvantage of these methods is a tendency to remove volatile product components. This is a particular problem with foods and beverages, wherein such components are often responsible for some or all of the aroma and flavor. These methods do not quantitatively remove all the oxygen from the package because complete evacuation is never achieved and oxygen often remains dissolved or trapped in the packaged product. In addition, when an inert gas backfill is used, the inert gas often brings traces of oxygen back into the package. Such vacuum or flushing methods, especially where inert gas handling is involved, often require machines of considerable cost and sophistication for high-speed packaging. It has proven extremely difficult to remove all traces of oxygen from packages of food products by mechanical means.

In conjunction with mechanical means, as far back as the 1960s, packaging containers were developed that envelop a product in an attempt to form a barrier within an oxygen-free package wherein free oxygen is ejected from the product and oxygen external to the package can be precluded. Such containers include modified atmosphere packaging (MAP) and oxygen barrier film packaging.

Another method used for regulating oxygen exposure is “active packaging”, whereby the package containing the food product has been modified in some manner to regulate the food's exposure to oxygen. This concept combines such systems as oxygen regulation (“oxygen scavenger”), moisture regulators, carbon dioxide (CO2) emitters, carbon dioxide (CO2) absorbers, ethylene absorbers and many more. One form of active packaging uses oxygen scavenging sachets which contain a composition which scavenges the oxygen through oxidation reactions. One common type of sachet contains iron-based compositions which oxidize to their ferric states. Another type of sachet contains unsaturated fatty acid salts on a particulate adsorbent. Yet another sachet contains metal/polyamide complexes. A disadvantage arising from the iron-based sachets is that certain atmospheric conditions (for example high humidity or low carbon dioxide levels) in the package are sometimes required in order for scavenging to occur at an adequate rate. Further, sachets containing synthetic chemical materials can present a problem to consumers if accidentally ingested.

Another means for regulating exposure of a packaged product to oxygen involves incorporating an oxygen scavenger into the packaging structure itself. A more uniform scavenging effect through the package is achieved by incorporating the scavenging material in the package instead of adding a separate scavenger structure such as a sachet to the package. Uniformity may be especially important where there is restricted airflow inside the package. In addition, incorporating the oxygen scavenger into the package structure provides a means of intercepting and scavenging oxygen as it permeates the walls of the package (the “active oxygen barrier”), thereby maintaining the lowest possible oxygen level in the package. Limited success has been achieved in incorporating oxygen scavenging material into the walls of packages for various types of foods. Previously developed scavengers include iron-based, sulfite-based, ascorbate-based and enzyme-based systems as well as oxidizable polyamides and ethylenically unsaturated hydrocarbons.

Iron-based scavengers are based on the oxidation of metallic irons to iron(II) hydroxide and iron(III) hydroxide. The reaction requires, in addition to certain promoters that have an accelerating action, moisture in order to start the scavenging process. This creates a trigger mechanism that enables purposeful activation. However, such scavengers are suitable only for products with a high moisture content. Some such materials can also be processed into sheets as well as into trays. However, general disadvantages when working powdery scavengers into polymer sheets are the reduced transparency and the deterioration of the mechanical properties of these sheets.

In the process of using sulfite-based scavengers, the absorption of oxygen takes place under the oxidation of potassium sulfite to sulfate. With these agents, activation also takes place by contact with moisture. The scavenger mixture is worked into polymers that do not have a sufficiently high water-vapor permeability until at elevated temperatures, e.g., during pasteurization or sterilization. According to publications from the American Can Company, crown corks for beer bottles are the primary area of use.

Ascorbate-based scavengers or mixtures of ascorbate and sulfite are more effective than purely sulfite-based systems. The process involves the oxidation of ascorbic acid to dehydroascorbic acid. Primarily sodium-L-ascorbate is used; however, derivatives of ascorbic acid can also be used. The oxidation reaction is accelerated by catalysts, preferably iron- and copper chelate complexes. Here again, moisture is the trigger for the operative reaction so that here too the use of these scavengers is limited to products with a high water content. Ascorbate-based scavengers are available as sachets as well as worked into crown corks and bottle closures. U.S. Pat. No. 6,391,406, for example, discloses a polymer container which is permeable to both oxygen and water or water vapor and an oxygen scavenging compound of an organic compound or salt thereof dispersed relatively uniformly throughout the polymer in an amount effective to act as an oxygen scavenger. The oxygen scavenging compound may be an ascorbate compound or a polycarboxylic or salicylic acid chelate or complex of a transition metal or a salt thereof. A catalyzing agent is included in an amount sufficient to increase the rate of oxygen scavenging by the ascorbate compound, while a reducing agent may be added to enhance the performance of the polycarboxylic or salicylic acid chelate or complex.

Methods for removing free oxygen from a closed package containing a moist food product by an enzyme system have been proposed. With respect to enzyme-based scavengers, the process involves the oxidation of glucose to gluconic acid and hydrogen peroxide catalyzed by glucose oxidase, which is rendered harmless by a further enzyme catalase, in that it is degraded to water and oxygen. The advantages of this system reside in the harmlessness of the natural components regarding food laws. A number of such products are sold in sachet form. However, these procedures require storage of cured meats in the dark for lengthy periods of time for the slow biological oxygen removal to take place, usually for at least one day, which is often undesired by food distributors and decreases the amount of viable time of a food product on the market. Another drawback to use of such scavengers is the possibility of the enzyme contacting the meat product which produces a greenish-brown colored meat surface which is highly undesirable to consumers.

Oxidizable polymers also include oxidizable polyamides and ethylenically unsaturated polymers. Primarily nylon poly-(m-xyxylene adipamide) is used. The activation of the scavenging process takes place via photoinitiation by UV radiation and cobalt is added as oxidation catalyst. Commercially available products based on this principle are used primarily in blends for PET bottles. However, polyamides have the disadvantage that they are incompatible with thermoplastic polymers and at times logistical or mechanical problems result during manufacturing at the required elevated temperatures of the extrusion process or the heat sealing process.

Ethylenically unsaturated hydrocarbons form the most versatile group of oxidizable substrates. Sachets that contain unsaturated fatty acids as active component are available. In addition, a number of oxidizable polymers are contained in this group such as polybutadiene, polyisoprene and their copolymers (U.S. Pat. Nos. 5,211,875; 5,346,644) but also acrylates with cycloolefins as side chains (WO 99/48963; U.S. Pat. No. 6,254,804). The latter group available on the market and offer a decisive advantages over other oxidizable, ethylenically unsaturated polymers—the structure of the polymer is not destroyed by the oxidation process, as is the case for the above-cited polymers, whose material properties deteriorate with an increasing degree of oxidation (WO 99/48963).

These resins, all terpolymers of the poly-(ethylene-methacrylate-cyclohexenylmethylacrylate) (EMCM) type, are produced by partial re-esterification of the methylacrylate with the appropriate alcohol. They can be used for stiff and flexible packaging and are distinguished by high transparency, high capacity and rapid kinetics. On account of the UV trigger mechanism, these acrylates are suitable for dry as well as for moist packaging product applications. The oxidation process is cobalt-catalyzed as in the oxidizable polyamides. On the other hand, the cyclic structure of the olefin hinders the production of low-molecular oxidation products, that have a damaging effect on the quality of the packaged material and are problematic as regards to food laws.

Attempts have been made to incorporate oxygen scavenging systems in a container crown or closure. For example, U.S. Pat. No. 4,279,350 discloses a closure liner which incorporates a catalyst disposed between an oxygen permeable barrier and a water absorbent backing layer. Another closure is disclosed in UK Patent Application 2,040,889. This closure is in the form of a stopper molded from ethylene vinyl acetate (“EVA”) having a closed-cell foamed core (which may contain water and sulfur dioxide to act as an oxygen scavenger) and a liquid impervious skin. Also, European Patent Application 328,336 discloses a preformed container closure element, such as a cap, removable panel or liner, formed of a polymeric matrix containing an oxygen scavenger therein. Preferred scavengers include ascorbates or isoascorbates, and their scavenging properties are activated by pasteurizing or sterilizing the element after it has been fitted onto a filled container. Similarly, European Patent Application 328,337 discloses a sealing composition for a container closure comprising a polymeric matrix material which is modified by the inclusion therein of an oxygen scavenger. These compositions may be in fluid or meltable form for application to a closure or be present as a deposit on the closure in the form of a closure gasket. Again, the scavenging properties of these compounds are activated by pasteurizing or sterilizing the deposit when sealing a container with the gasket on a closure or metal cap.

Effective, safe, and environmentally-friendly packaging materials and containers useful for food, pharmaceutical, cosmetics and other industry applications are still highly desired in the packaging industry with improved oxygen regulating properties. In the food industry, for example, in order to preserve the color and flavor of certain food products, it is necessary to remove even minimal traces of oxygen from the package and the package must be maintained oxygen-free throughout the desired shelf life of the product. Currently, in this regard, small amounts of oxygen permeate many of the relatively gas-impermeable flexible packaging materials presently available commercially.

It is, therefore, an object of this invention to provide an improved method for packaging of oxygen-deteriorative or oxygen sensitive products wherein residual free oxygen is removed or substantially removed from the package. It is a further object of the invention to provide a package which will remain oxygen-free or substantially oxygen-free for the desired storage period of the product or component packaged therein. A still further object of the invention is to provide an improved method for packaging products wherein the level of oxygen in the package is controlled. Another object of the invention is to provide a sealed package for food products wherein free oxygen is effectively removed (entirely or substantially) while maintaining an interior environment for the product stored in the package that keeps the product, (such as a food item) safe and healthy for consumers. A further object of the invention is to provide a material which is suitable for forming an oxygen-free, substantially oxygen-free or oxygen modified package.

As relating to the food packaging industry, the oxygen scavenging materials of the present invention provide the benefits of extending shelf life, preserving color, taste and odor, reducing mold growth and retaining vitamins and other nutritional value.

Furthermore, packaging components and materials are increasingly used to extend a purpose beyond transport, containment and preservation of products. Materials used in packaging are often a design element chosen for its storytelling aspect of marketing and brand development. Addition of synthetic antioxidants and oxygen scavengers to foods or beverages requires labeling that the product contains the additive. As such, synthetic additives are becoming increasingly more undesirable in today's era of fresh and “all-natural” products.

In addition, due to increasing consumer awareness and social consciousness, the characteristic of packaging products that minimize impact on the environment is of growing importance. Package development involves considerations of environmental responsibility and environmental regulations, recycling regulations and waste management. Consequently, there is a need for an oxygen scavenging material which is especially consumer oriented, safe, environmentally conscious and biodegradable.

### SUMMARY

The oxygen scavenging material disclosed herein is the substance commonly known as tea. It has been reported that tea is the most popular drink consumed in the world, equaling all others including coffee, chocolate, soft drinks, and alcohol combined. The present inventors have discovered that when incorporated into package materials, tea functions to address many of the challenges sought to be addressed in the packaging industry related with packaging of oxygen sensitive products.

The present invention concerns the use of tea-based oxygen scavenging materials which may be used as sachets or dispersed in various carriers, such as polymers or composites, and used in packaging as oxygen scavenging compositions. These compositions, by virtue of novel and unexpected increases in oxygen uptake rates of the incorporated oxygen scavenging material, are useful in preventing deterioration or reaction of the oxygen sensitive packaged substances due to exposure to oxygen in the package and in reducing oxygen-initiated degradation of oxygen sensitive products.

### BRIEF DESCRIPTION OF THE DRAWINGS

The invention will be described in conjunction with the following drawings in which like reference numerals designate like elements and wherein:

FIG. 1 is a cross sectional view of a sheet or film formed of a polymer composition comprising the oxygen scavenging agent according to an optional embodiment of the present invention, adhered to a barrier sheet substrate.

FIG. 2 is a close-up schematic view of the entrained polymer according to FIG. 1 showing the tea oxygen scavenging agent.

FIG. 3 is a cross section of a package that may be formed using an entrained polymer comprising the oxygen scavenging agent according to an optional embodiment of the present invention.

FIG. 4 is a representational graph showing the experimental results of Example 1 of an oxygen scavenging film according to the invention.

FIG. 5 is a second representational graph showing the experimental results of Example 2 of an oxygen scavenging film according to the invention as compared to an alternate control oxygen scavenging film.

FIG. 6 is a graph of the experimental results of Example 3 showing the oxygen scavenging capacity of an embodiment of a film according to the invention with and without the presence of water in a sealed container.

FIG. 7 is a graph of the experimental results of Example 4 showing the performance of an embodiment of the oxygen scavenging agent of the invention comprising black tea.

### DETAILED DESCRIPTION OF THE INVENTION

The methods and tea-based oxygen scavenging packaging materials and containers of the invention provide a natural, safe and healthy product solution for packaging, oxygen control and preservation of oxygen sensitive products. This also presents an environmentally responsible alternative solution having long-term environmental impact on a multi-billion dollar global packaging industry.

Herein, the term “oxygen scavenger” means a compound, composition or material which can remove or reduce the level, amount and/or concentration of oxygen from the interior (e.g., from the air or empty space within the interior) of a closed package or container by reacting or combining with entrapped oxygen or with oxygen that is entering into the package interior past or through the packaging material or closure sealing device and/or a compound which can control the level of oxygen within the package. “Oxygen scavenging”, “oxygen regulating” and “oxygen control” are used interchangeably herein. As used herein, the term “concentration” with reference to “oxygen concentration” means the amount of oxygen gas in relation to the total volume of air as measured inside a particular closed container.

Generally, the oxygen scavenging material of the invention may also function as an “antioxidant”, a substance that inhibits oxidation and refers to a material or compound which, when added to foodstuffs, beverages, cosmetics, pharmaceuticals, tobacco or cannabis, slows the rate of oxidation or otherwise reduces the undesirable effects of oxidation upon the respective object, such as a foodstuff, beverage, cosmetic, pharmaceutical, tobacco or cannabis product.

The oxygen scavenging active material of the invention herein is commonly known as “tea”. As used herein, the term “tea” refers to the natural, uncured, cured or otherwise processed parts of the Camellia sinensis plant or shrub genus, (which term is used interchangeably herein with its common usage, the “tea plant”.) All specimen of the Camellia sinensis tea plant are contemplated within optional aspects and scope of the invention. According to a preferred embodiment, tea leaves are used as the active oxygen scavenging material. However, the tea material herein is not limited to the leaves of the tea plant; all parts of the tea plant such as buds, stems, and steeps are contemplated according to the invention to the extent that they operate in a capacity and at a level sufficient to effect oxygen modification within a sealed container.

The tea material for use according to the invention can be in its original non-processed raw form or can be processed according to techniques commonly utilized in tea production for the particular type of tea. Tea is generally divided into types or categories based on the method by which the tea, typically the leaves of the tea specimen, are prepared and/or processed after harvesting. At least six different types are produced worldwide: “white” tea is wilted and unoxidized; “black” tea is wilted, sometimes crushed, and fully oxidized (called [symbol] [hóngchá] or “red tea” in Chinese and other East Asian tea cultures); “yellow” tea is unwilted and unoxidized but allowed to yellow; “oolong” tea is wilted, bruised, and partially oxidized; “green” tea is unwilted and unoxidized; and “post-fermented” tea is green tea that has been allowed to ferment or compost (called [hēichá] “black tea” in Chinese tea culture). Green tea is a particularly preferred embodiment of a specimen used according to the invention.

Some popular types of Chinese green tea include, but are not limited to, Biluochun, produced in Jiangsu, is named after the shape of the leaves, which are curled like snails; Chun Mee, known in English by its Cantonese name, and popular outside China, has a plum-like flavor; Gunpowder tea, is a tea which is tumble-dried so that each leaf is rolled into a small pellet that resembles gunpowder; Huangshan Maofeng is a type of maofeng tea grown in the microclimate of the Huangshan mountain range in Anhui province and is harvested by plucking intact two equal-sized leaves and a bud together; Longjing, also known as “Dragon Well” tea in English translation is grown near Hangzhou in Zhejiang province and is the most well-known pan-fired Chinese green tea having its flavor derived partly from the terrain of the region in which it is produced; Lu'an Melon Seed is grown in Anhui province and unlike typical Chinese tea harvesting, two leaves are plucked separately from each branch, with no bud and no stems and it has a grassier flavor than typical Chinese green teas; Taiping Houkui is grown in Anhui province and uses a cultivar with an unusually large leaf whereby the production process flattens the tea leaves, creating the so-called “two knives and a pole” shape from the leaves and stem; Xinyang Maojian is a type of maojian tea grown in Xinyang, Henan province and is harvested by plucking a bud and one leaf together.

Popular Japanese green teas include: Bancha, a lower-grade tea plucked from the same bushes used to produce sencha, it has a somewhat bolder flavor and is plucked each season after sencha production is finished; Genmaicha is made by combining sencha tea leaves with toasted puffs of rice; Gyokuro is grown under shade for three weeks prior to plucking and is one of the most exclusive varieties of tea produced in Japan, the shading technique imparts a sweeter flavor, and produces a particularly rich color as a result of the higher amounts of chlorophyll in the shaded leaf. Gyokuro tea is associated with the Uji region, the first tea-growing region in Japan, it is often made using smaller-leaf cultivars of the tea plant; Hōjicha is a type of tea made by roasting sencha or bancha leaves with kukicha twigs; Kabusecha is similar to gyokuro, it is shaded for only a week prior to plucking, its flavor is somewhat between that of gyokuro and normal sencha; Kukicha is a blended tea made of sencha leaves and stems; Matcha, like gyokuro, is shaded before plucking. The plucked and processed leaf is called tencha. This product is then ground into a fine powder, which is matcha. Because the tea powder is very perishable, matcha is usually sold in small quantities and is typically rather expensive. Matcha is the type of tea used in the Japanese tea ceremony. Sencha is produced throughout the tea season, and is the most common, representing 80% of all tea produced in Japan. 90% of sencha is grown from the Yabukita cultivar; Shincha, the first early harvest of tea, is plucked before the first flush, is made from the youngest new growth leaves, and is plucked from early April to early May. Shincha typically refers to the early harvest of sencha, but can refer to any type of tea plucked early in the season, before the main harvest. Because of the limited quantities in which it is produced, shincha is highly prized and expensive to obtain.

Korean green tea is similarly classified into various types based on several different factors, the most common being the flush, or the time of the year when the leaves are plucked (and thus also by leaf size). Korean teas include ujeon, sejak, jungjak, daejak, ipcha, garucha, deokkeum-cha, jeungje-cha, banya-cha, jungno-cha, (“bamboo dew tea”), one of the most popular Korean green teas, made of tea leaves grown among the bamboo in Gimhae, Hadong, and Jinju in South Gyeongsang Province.

Optional embodiments of the invention include any of the cultivars of green teas set forth above and are believed to be operable as oxygen scavenging material agents incorporated into packaging materials according to the invention. Without being limited to a particular mechanism of action, it is thought that the level of oxidation of the tea is related to its oxygen scavenging capability whereby the less oxidized the tea, the better it functions as an oxygen scavenger within a container. Thereby, green tea is the preferred embodiment of the tea-active scavenging material of the invention because it is typically the least oxidized of the six different general types of tea classified, as compared to black tea, oolong tea or post-fermented tea. As such, green tea also functions longer within a sealed container to modify or control the level of oxygen within the container of the invention as compared to other types of teas. The oxygen scavenging functionality of different species of green tea are believed also to operate according to this general principal and as such, embodiments of the invention comprising different species of green tea will be selected according to their unique oxygen scavenging capabilities. Containers enabling long periods of oxygen modification or control are particularly desired for applications such as, for example, the storage of pharmaceutical products and food storage, such as seafood, thus green tea will be the preferred oxygen scavenging material for such applications. In packaging requiring shorter periods of oxygen control, such as for example, paper packaging for shipping of electronic components, the use of other types of tea-based packaging materials may be desirable based on other factors. For example, where cost is an important factor for consideration, teas other than green tea, such as black tea, may be more cost effective for production than green tea.

The form of the tea component material herein can be supplied to the package or utilized according to the invention in crude form, whole parts, such as entire leaves; or it can be crushed, chopped, sliced, ground, or otherwise processed into finer parts or into powder form. In an optional embodiment, the tea is supplied in dried powdered form. Alternatively, the tea undergoes processing such as through brewing in water, after which the resulting brewed tea liquid is dehydrated and provided in dry powder form. In any case, various ways in which the oxygen scavenging agent according to the invention may be derived from the Camellia sinensis tea plant, are contemplated.

The terms “package,” “packaging” and “container” are used interchangeably herein to indicate a receptacle that is capable of holding or containing an object (i.e. product) within. Optionally, a package or container may include or hold an object (i.e. product) stored therein or it may remain empty. “Headspace” refers to any empty space surrounding an object stored within the interior space of the package or container. Non-limiting examples of a package, packaging and container include a tray, box, carton, bottle, vessel, pouch, flexible bag or any other receptacle capable of holding an object. In certain embodiments, the oxygen scavenging component is located in the headspace or other compartment of the container and does not physically contact the oxygen sensitive product.

In the preferred embodiment, the package or container is closed or covered. It is contemplated and understood that any type of cover may be used which is appropriate with the use of the particular container, such as a cover, a cap, a lid, a plug, a stopper, a cork, a gasket, a seal, a washer, a liner, a ring, a disk, or any other closure device. Optionally, the cover or closure device is transparent so that the interior can be viewed. The cover or closure device may optionally be further sealed onto the package using a variety of processes including but not limited to, for example, a lidding sealant, an adhesive, or a heat seal. The container or package of the invention can be used in commerce for any purpose such as food transportation, preservation and/or storage. The shape or geometry of the container or package is not limited.

According to one embodiment, provided is a method of reducing the amount or oxygen level in a container by providing a sachet comprising the tea or a tea-based material specimen. The sachet may be presented in any desirable shape or configuration, for example, the sachet may be in a geometric shape, such as, a circle or an ornamental shape such as a flower. The sachet may have additional parts such as flaps. Typically, in accordance with the present invention, the sachet shall be comprised of an oxygen-permeable envelope used for the body of the sachet. For food applications, the sachet will be of food grade filter paper or gauze material. In an embodiment, the sachet containing the tea component is provided and retained directly in a container. In an embodiment, the sachet is placed in direct contact with the packaged product, such as in a vacuum sealed package. In an alternate embodiment, the sachet is retained in the headspace of a package. In an alternate embodiment, the sachet is placed into a separate compartment that adjoins the product retention compartment wherein the oxygen is able to permeate between the two compartments enabling the tea-based agent to react and thereby affect the level of oxygen within the entire container.

According to a preferred embodiment, tea or tea-based compositions are incorporated directly into the packaging material or a component thereof. Standard materials commonly used in the package production industry are plastics, paper, glass, metals, synthetic resins and combinations thereof. The oxygen scavenging property of the tea component is typically activated for scavenging oxygen by contact with atmospheric moisture, moisture content in the package or moisture in the form of vapor that permeates into or through the package or in the form of liquid that is introduced into the package via an external means. According to an embodiment, the tea-based oxygen scavenging compound is retained in the packaging material in a dry state and remains substantially inactive until activated for oxygen scavenging by contact with water or water vapor. It is a distinct advantage of the invention that no metal salts or photoinitiators are required in order to initiate the oxygen scavenging properties of the invention.

The tea-based oxygen scavenging compositions and materials of the invention function to control oxygen levels by reducing or maintaining a certain amount of oxygen within a package. The amount of oxygen within the package will be to some extent controlled by the amount of the tea-based agent that is incorporated into the composition or the material, and will depend on the desired particular end-use application of the package or of the product to be maintained in the package.

According to a preferred embodiment, the tea or tea-based composition is incorporated into a polymer or combination of polymers. An additional benefit of this embodiment is that the scavenging materials do not need to be provided separately as sachets into the container package thereby eliminating the additional handling steps and safety concerns associated with oxygen scavenging sachets.

According to an embodiment, the oxygen scavenging materials of the invention are incorporated into films and or sheets typically made of layers of film and the terms “film” and “sheet” are used synonymously herein. The tea-based component that is reactive towards oxygen may either be embedded in the matrix of the film or incorporated covalently therein. The sheet of material may be either totally or partially clear, tinted transparent material or opaque, depending on its desired use.

According to yet another embodiment, the tea-based component is incorporated into a composite material composed of a plurality of layers of sheets joined together. For example, the matrix may be formed from an organic-inorganic hybrid polymer; alternatively it may have a purely organic construction.

Optionally, in an embodiment, in the tea components are incorporated into a film (e.g., polymer film) that is disposed onto or within the walls of a food package. Optionally, the film may be adhered, e.g., using an adhesive, to an inner surface of the package. Alternatively, the film may be heat staked (without an adhesive) to the inner surface of the package. The process of heat staking film onto a substrate is known in the art and described in detail in U.S. Pat. No. 8,142,603, which is incorporated by reference herein in its entirety. Advantageously, heat staking allows the film to permanently adhere to the sidewall without use of an adhesive. An adhesive may be problematic in some circumstances because it may release unwanted volatiles in a food-containing headspace. Heat staking, in this instance, refers to heating a sealing layer substrate on the sidewall while exerting sufficient pressure on the film and sealing layer substrate to adhere the film to the container wall. Optionally, the polymer film or layer is deposited and adhered to the package via a direct in-line melt adhesion process, e.g., as taught in Applicants' published Application Nos. WO 2018/161091 and WO 2019/172953, each of which is incorporated by reference herein in its entirety.

Alternatively, the film may be placed inside the package without being adhered or affixed to a surface. The size and thickness of the film can vary. Optionally, the film may range from 0.1 mm to 1.2 mm, more preferably from 0.2 mm to 0.6 mm. In certain embodiments, the film has a thickness of approximately 0.2 mm or 0.3 mm.

Suitable polymer materials useful herein include thermoplastic polymers such as polypropylene, polyethylene, and polyoxmethylene, polyolefins such as polypropylene and polyethylene, olefin copolymers, polyisoprene, polybutadiene, acrylonitrile butadiene styrene (ABS), polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof. In one optional embodiment, the package or container is composed of a rigid or semi-rigid polymer, optionally polypropylene or polyethylene, and preferably has sufficient rigidity to retain its shape under gravity.

The films or polymers comprising the tea-based active materials according to the invention are preferably produced by extrusion molding, injection molding, blow molding or vacuum molding using standard molding equipment, as will be dictated by the intended particular product application and are generally well known.

A film composition incorporating the tea-based material according to the invention can be placed directly or wrapped directly around the entire package or container, be placed on part of the container or be placed on the object or on part of the object requiring oxygen control. For a food product, the item can be wrapped directly with the film product of the invention, that in an embodiment, will typically be provided in the form of polyethylene film commonly known as “cling-wrap”, “shrink wrap” or “saran wrap” (formerly a registered trademark of Johnson Home Storage, Inc., Delaware, USA). Alternatively, a layer or multiple layers of the film of the invention can be placed into any container in order to convey the oxygen-scavenging characteristics of the invention to such container and thereby reduce the level of oxygen within the container. The desired specific OTR (oxygen transport rate) of the wrap will typically depend upon the desired end-use application, such as foods to be packaged.

In an alternate embodiment, the tea or tea-based oxygen scavenging material is incorporated into an entrained polymer. Entrained polymers are composed of generally monolithic material having an essentially uniform composition formed of at least a base polymer, an active agent and optionally a channeling agent entrained or distributed throughout. An entrained polymer thus comprises at least two phases (the base polymer and active agent, without a channeling agent) or at least three phases (base polymer, active agent and a channeling agent). As used herein, the term “three phase” is defined as a monolithic composition or structure comprising three or more phases. An example of a three phase composition is an entrained polymer formed of a base polymer, active agent, and channeling agent. Optionally, a three phase composition or structure may include an additional phase, such as a colorant or antibacterial agent, but is nonetheless still considered “three phase” on account of the presence of the three primary functional components.

The methods of producing entrained polymers according to the present invention are not particularly limited. The entrained polymer may be manufactured, extruded, molded, attached, adhered, placed, or otherwise included in any container or package via conventional methods as discussed above. Preferably, the entrained polymers according to the invention comprising the tea-based active agents, molded by extrusion or injection molding into a variety of desired forms, e.g., containers, molds, container liners, plugs, films, pellets and other such structures.

Typical production of the three phase entrained polymer includes blending a base polymer, the active material and a channeling agent. The active agent is blended into the base polymer either before or after adding the channeling agent. All three components are distributed within the entrained polymer mixture, preferably but not necessarily uniformly. The entrained polymer thus prepared contains at least three phases. Entrained polymers are further described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth herein.

Suitable channeling agents of the entrained polymer operable herein include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent can be, for example, a water insoluble polymer, such as a polypropylene oxide-monobutyl ether, polyethylene glycol, which is commercially available under the trade name Polyglykol B01/240; polypropylene oxide monobutyl ether, which is commercially available under the trade name Polyglykol B01/20; and/or polypropylene oxide, which is commercially available under the trade name Polyglykol D01/240, all produced by Clamant Specialty Chemicals Corporation. Other embodiments of channeling agents comprise ethylene vinyl acetate, nylon 6, nylon 66, or any combination of the foregoing. Optionally, the optional channeling agent ranges from 1% to 25%, optionally from 1% to 15%, optionally from 2% to 20%, optionally from 2% to 12%, optionally from 5% to 15%, optionally from 5% to 10%, optionally from 8% to 15%, optionally from 8% to 10%, optionally from 10% to 20%, optionally from 10% to 15%, or optionally from 10% to 12% by weight with respect to the total weight of the entrained polymer.

Optionally, in an embodiment of a container of the invention, the entrained polymer is covered with a barrier film on one or both sides of the surface of the polymer in order to protect the tea-based oxygen scavenging active agent from potential premature reaction with moisture within the container. The barrier film is preferably gas or moisture impermeable. When the entrained polymer is placed in the container, the barrier film is removed, allowing the tea-based oxygen scavenging agent to perform.

Optionally, the entrained polymer may also be covered with a backing film on one or both sides. The backing film may be gas or moisture permeable to allow the tea-based oxygen scavenging component to travel to the surrounding environment. For example, a high-density polyethylene film, such as a nonwoven film (e.g. TYVEK® by E.I. du Pont de Nemours and Company), may be used as a gas permeable backing film.

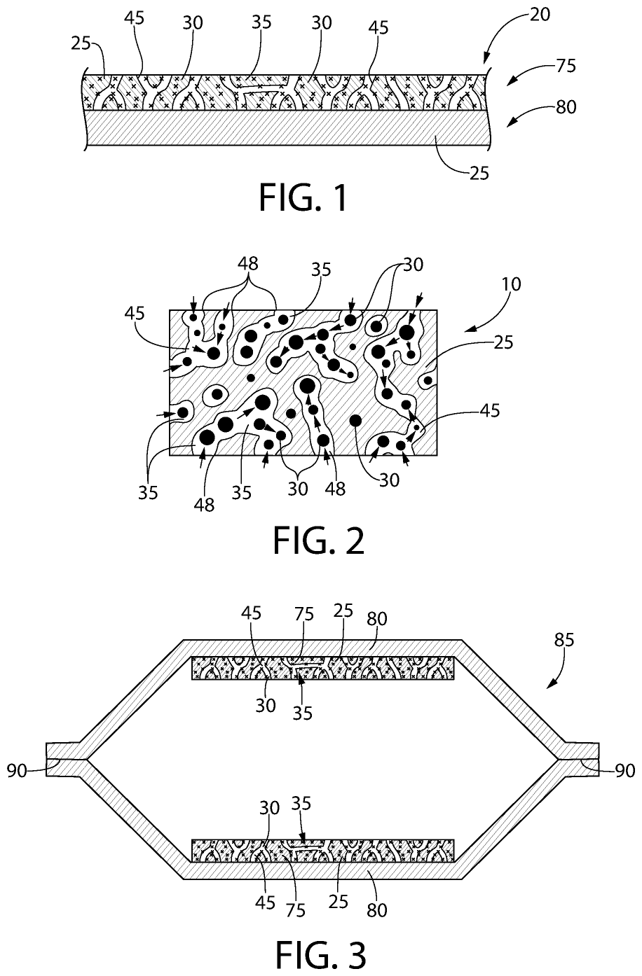

FIGS. 1 and 2 are a schematic illustration of an active sheet or film 75 formed of base polymer 25 with channeling agent 35 and the tea oxygen scavenging active agent 30 forming entrained polymer 20. FIG. 1 illustrates film 75 used in combination with a barrier sheet 80 to form a composite, according to an optional aspect of the invention. FIG. 2 is a close-up schematic view of the entrained polymer of FIG. 1. A channeling agent 35 forms interconnecting channels 45 through the entrained polymer 20. At least some of the active agent 30 is contained within these channels 45, such that the channels 45 enable communication between the active agent 30 and the exterior of the entrained polymer 20 via channel openings 48 formed at outer surfaces 25 of the entrained polymer 20. FIG. 2 shows the tea active agent 30 with arrows indicating the path 10 of moisture (not shown) from an exterior of the entrained polymer 20, through the channels 45, to the particles of active agent 30 for initiation of oxygen scavenging activity.

FIG. 3 illustrates an optional embodiment in which the active sheet or film 75 and the barrier sheet 80 are combined to form a package 85 in the form of a wrap having active characteristics at an interior surface formed by the entrained polymer 20 in the active sheet or film 75, and moisture vapor resistant characteristics at an exterior surface formed by the barrier sheet 80. In this embodiment, the active sheet or film 75 occupies a portion of the barrier sheet 80. The barrier sheet 80 may be a substrate such as foil and/or a polymer with low moisture and/or oxygen permeability. The barrier sheet 80 is compatible with the entrained polymer structure 75 and is thus configured to thermally bond to the active sheet or film 75, when the active sheet or film 75 solidifies after dispensing. As illustrated, the sheets are joined together to form an active package 85. As shown, two laminates or composites are provided, each formed of an active sheet or film 75 joined with a barrier sheet 80. The sheet laminates are stacked, with the active sheet or film 75 facing one another, so as to be disposed on an interior of the package, and are joined at a sealing region 90, formed about a perimeter of the sealed region of the package interior.

Optionally, within an embodiment of a polymer composition according to the invention, the tea-based oxygen scavenging active agent loading level is in an amount or concentration sufficient to be effective to act as an oxygen scavenger. Preferably, the concentration of the tea-based active agent ranges from 0.1% to 70%, optionally from 5% to 60%, optionally from 10% to 50%, optionally from 20% to 40%, optionally from 30% to 35% by weight with respect to the total weight of the polymer composition with the loading of the base polymer, optionally, the channeling agent, and optionally other additives such as colorant, forming the remainder of the polymer composition. The amount of the tea-based active component is chosen according to the level of oxygen and amount of oxygen control desired in the container depending on the particular product to be contained within.

Optionally, an entrained polymer may be a two phase formulation including 20% to 70% by weight of the tea-based oxygen scavenging agent, preferably in powder form, 30% to 80% by weight a base polymer (such as polyethylene, polyethylene-based copolymer, polypropylene, ethylene vinyl acetate (EVA), or a mixture). The base polymer is not particularly limited. Optionally, an entrained polymer may be a three phase formulation including 20% to 60% by weight of the tea-based oxygen scavenging agent, preferably in a powder form, 30% to 70% by weight a base polymer (such as polyethylene, polyethylene-based copolymer, polypropylene, ethylene vinyl acetate (EVA), or a mixture), and 2-15% by weight a channeling agent (such as a PEG). The base polymer and the channeling agent are not particularly limited.

According to an alternate embodiment, rather than incorporating the tea-based oxygen scavenging agent into or onto a base polymer, the tea-based oxygen scavenging agent may also be combined with, suspended in, or otherwise incorporated into an absorbent material directed to and suitable for absorbency of liquids or moisture within the container in order to enhance oxygen scavenging control and regulation within the container. For example, the tea-based oxygen scavenging agent can be combined directly with an absorbent matrix material.

An example of such a matrix material is an adsorbent composition of matter as disclosed in U.S. Pat. No. 6,376,034, which is incorporated by reference herein in its entirety. The absorbent composition of matter or “absorbent packet” used interchangeably herein, has an absorbency, the absorbency being defined by weight of liquid absorbed/weight of the absorbent composition of matter. The absorbent composition of matter includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one mineral composition having a second absorbency, the second absorbency being defined by weight of liquid absorbed/weight of the at least one mineral composition, the at least one mineral composition being food safe, the absorbency of the absorbent composition of matter exceeding a sum of the first absorbency and the second absorbency, the absorbent composition of matter being compatible with food products such that the absorbent composition of matter is food safe when in direct contact with the food products. Optionally, the absorbent composition of matter includes additionally: (iii) at least one soluble salt having at least one trivalent cation, the at least one soluble salt having at least one trivalent cation being food safe.

The absorbent material contains from about 10 to 90% by weight, preferably from about 50 to about 80% by weight, and most preferably from about 70 to 75% by weight of a non-crosslinked gel forming polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a combination of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa.

The clay ingredient in the matrix material can be any of a variety of materials and is preferably attapulgite, montmorillonite (including bentonite clays such as hectorite), sericite, kaolin, diatomaceous earth, silica, and other similar materials, and combinations thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Diatomaceous earth is formed from the fossilized remains of diatoms, which are structured somewhat like honeycomb or sponge. Diatomaceous earth absorbs fluids without swelling by accumulating the fluids in the interstices of the structure. Additional specific preferred absorbent materials for use herein include potassium aluminum sulfate, soda ash (sodium carbonate), alginate, and calcium chloride.

Optionally, a soluble salt is provided in order to render a trivalent cation. The soluble salt is optionally derived from aluminum sulfate, potassium aluminum sulfate, and other soluble salts of metal ions such as aluminum, chromium, and the like. Preferably, the trivalent cation is present at about 1 to 20%, most preferably at about 1 to 8%. If a buffer is used, it is present preferably at about 0.6%, however beneficial results have been achieved with amounts up to about 15% by weight. An optional inorganic buffer is one such as sodium carbonate (soda ash), sodium hexametaphosphate, sodium tripolyphosphate, and other similar materials.

The combination of the non-crosslinked gel forming polymer, trivalent cation, and clay forms an absorbent material which when hydrated has an improved gel strength over the non-crosslinked gel forming polymer alone. Further, the gel exhibits minimal syneresis, which is exudation of the liquid component of a gel. In addition, the combined ingredients form an absorbent which has an absorbent capacity which exceeds the total absorbent capacity of the ingredients individually. The tea-based oxygen scavenging component may function to further enhance the moisture absorbing characteristics of this absorbent material. The oxygen scavenging absorbent gel compositions according to the invention may be glass clear, firm gels which may have applications in areas such as for preservation of the shelf life of cosmetic products, for example.

The resulting absorbent material can be fashioned into a number of different structures or flexible packages, such as pouches, thermoformed packs, lidding materials, or other packages of various sizes and geometric shapes. In an embodiment, for example, a two-ply wall within the package can be made by standard techniques such as a two wall sheath of material or the flexible packs with two-ply walls, one or both of which may comprise the absorbent material.

The permeable or inner ply of the absorbent wall can have a dual layer structure with two layers of the same fibers. The fibers are packed more closely together on the side which is closer to the absorbent and are packed into a more open network on the side closer to the packaged products. In this way the absorbent ply has smaller pores on the side closer to the absorbent and the absorbent is thus unlikely to migrate through the fabric. On the other hand, the ply next to the liquid typically has larger pores to encourage migration of the liquid throughout. While a specific embodiment of a flexible package is described, other embodiments of flexible packages are envisioned utilizing the tea-based oxygen scavenging component absorbent composition described herein.

As discovered from experiments conducted in the investigation of the invention, it was noted that in alternate embodiments of the containers comprising the tea component, liquid or moisture within the container served to improve the oxygen scavenging characteristics of the container, causing the decrease in the level and concentration of oxygen within the container environment or headspace. Without being bound to a mechanism of action, it is thought that the liquid component functions to initiate, further facilitate, hasten, or augment the oxygen scavenging reaction of the tea component. Thus, in a preferred embodiment of the invention, a liquid such as water is added to a sealed container of the invention. Any liquid or solution may be utilized and will depend on the compatibility of the liquid component with the object being stored within a container. Other moisture-containing compositions which exude moisture, such as gels, lotions, creams, may be utilized and will also be dictated by the desired use of the container.

In certain embodiments, the polymer comprising the tea based active agent is activated once a barrier film is removed and the tea active is exposed to the atmospheric moisture within the container or moisture coming from the object help within the container. In certain embodiments, a controlled release or a desired release profile can be achieved by applying a coating to the active agent, such as for example, such as using a spray coater, wherein the coating is configured to release the tea component within a desired time frame. Different coatings may be applied to achieve different release effects. For example, the film may be coated with extended release coatings of varying thicknesses and/or properties to achieve the desired release profile. For example, some active agent will be coated such that the polymer composition will not begin oxygen scavenging until after a few hours or a few days, while other coating agents will allow oxygen scavenging to begin immediately. Spray coating technology is known in the art. For example, pharmaceutical beads and the like are spray coated to control the release rate of active ingredient, e.g., to create extended or sustained release drugs. Optionally, such technology may be adapted to apply coatings to the active agent to achieve a desired controlled rate of oxygen modification in the container of the invention.

Alternatively, a controlled release and/or desired release profile may be achieved by providing a layer, optionally on both sides of a film according to the invention, of a material configured to control exposure. For example, the film may include a polymer liner, made e.g., from low density polyethylene (LDPE) disposed on either side or both sides thereof. The thickness of the film and liner(s) can vary as disclosed above. The LDPE liners may be coextruded with the film or laminated thereon.

Alternatively, a controlled release and/or desired release profile may be achieved by modifying the formulation of an entrained polymer according to the invention. For example, adjusting the type and the concentration of the channeling agent to provide a desired control rate of the oxygen scavenging tea agent.

In optional embodiments, the tea-based oxygen scavenging active in accordance with the invention may be combined with other oxygen scavenging agents in order to achieve and control desired oxygen levels. Such other oxygen scavenging materials include, but are not limited to, oxidizable polymers, ethylenically unsaturated polymers, benzylic polymers, allylic polymers, polybutadiene, poly[ethylene-methyl-acrylate-cyclohexene acrylate] terpolymers, poly[ethylene-vinylcyclohexene] copolymers, polylimonene resins, poly beta-pinene, poly alpha-pinene and a combination of a polymeric backbone, cyclic olefinic pendent groups and linking groups linking the olefinic pendent groups to the polymeric backbone. Other additional oxygen scavenging agents can include polycarboxylic or salicylic acid chelate or complexes.

Furthermore, although no metal salts or photoinitiators are required in order to initiate the tea-based oxygen scavenging materials of the invention, in optional embodiments, incorporating other oxygen scavenging materials, metals salts and photoinitiators may be may be utilized in order to further catalyze the oxygen scavenging properties of such materials.

In alternate embodiments, the choice of the tea component herein for use according the invention will be chosen for its ornamental properties in addition to its oxygen scavenging characteristics. For example, certain tea leaves can be used in a decorative pattern chosen for the color and/or shape of the leaves, and/or other decorative surface ornamentation, which can be incorporated into the films or directly into the polymer compositions of the invention. Such packaging may be desired by consumers for their aesthetic characteristics, such as, for example, in packaging for cosmetics, lotions, creams, shampoos, or other such products. The color of the package can also be controlled by the particular tea specimen used herein in manufacturing the products, such as, for example, various shades of green containers may be produced depending on the hue of a powdered form of tea specimen used in manufacturing.

The invention is further illustrated in more detail with reference to the following Examples, but it should be understood that the invention is not deemed to be limited thereto.

### EXAMPLES

### Example 1

Fifteen samples of polymer film were prepared composed of seven different formulations. Samples 1 to 3 contained polymer with green tea leaf and colorant; samples 4 to 6 contained polymer film with green tea incorporated into the polymer in powder form; samples 7 to 9 contained polymer film with pre-ground green tea leaves; samples 10 to 12 contained polymer film with decaffeinated green tea; samples 13 to 15 contained TYVEK® film on both sides (from DuPont de Nemours, Inc. of Wilmington, Delaware, USA), blue colorant, and green tea. Each sample was placed into either a glass 2.1 L Mason Jar with a strip of filter paper (Whatman™ 110 mm diameter circle paper from GE Healthcare Life Sciences) which was squirted with one 1 mL drop of water and the sample sealed with an air tight screw top lid. Another set of samples were placed in the same way into a 120 mL serum vial and sealed with a lid crimped onto the vial. The level of oxygen within the containers was measured approximately each day or every few days for a period of 330 days using OXYSENSE® oxygen measuring system and technique of OxySense Inc., Devens, MA, USA, (https://www.oxysense.com/how-oxysense-works.html) consisting of probes glued to the inside of the sample chamber wherein a florescent pen causes the probe to phosphoresce at a varying intensity based upon the oxygen concentration in the chamber.

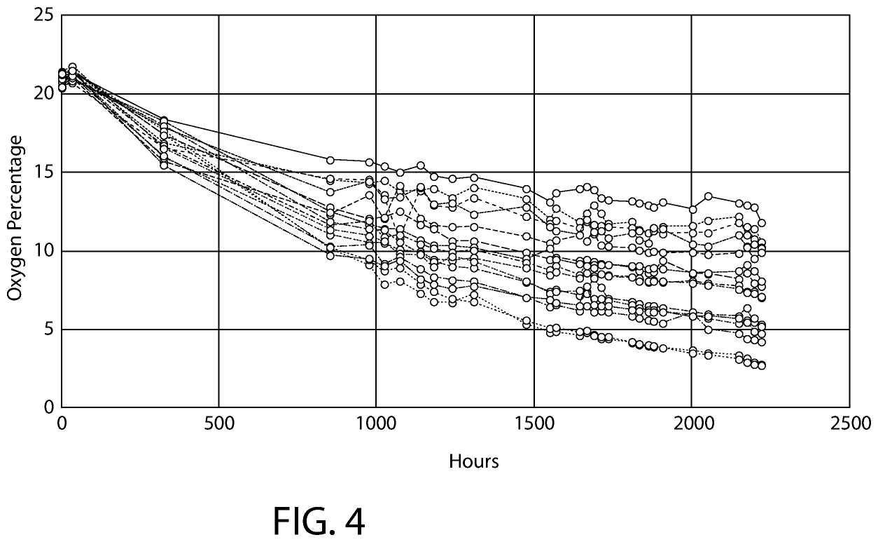

The oxygen concentrations as measured were recorded. FIG. 4 demonstrates the recorded results for each of the 15 samples up to appx. 2200 hours of the test period. The results clearly show the oxygen scavenging effect of the film of the invention. The concentration of oxygen in the containers was significantly reduced for all of the 15 samples tested. Test results also demonstrated a difference or spread in the concentration, i.e., effectiveness of oxygen scavenging between the seven different formulations, as can be seen on FIG. 4. FIG. 4 shows a general trend of oxygen scavenging across various formulations in varying degree. Without being bound to any mechanism of action, it is thought that the difference in oxygen scavenging effect by the active film was a result of the preparation process of the tea component incorporated into the polymer composition. The test samples that show a lower oxygen scavenging effect, performance could have been affected by prior oxidation of the tea active agent during its processing or longer storage times as compared to freshly ground and used tea leaves.

As such, specific processing or preparation of the tea component, (in addition to the amount of the tea component and the formulation and concentrations of other components), will be a factor in the design of polymer compositions with specific oxygen scavenging properties.

### Example 2

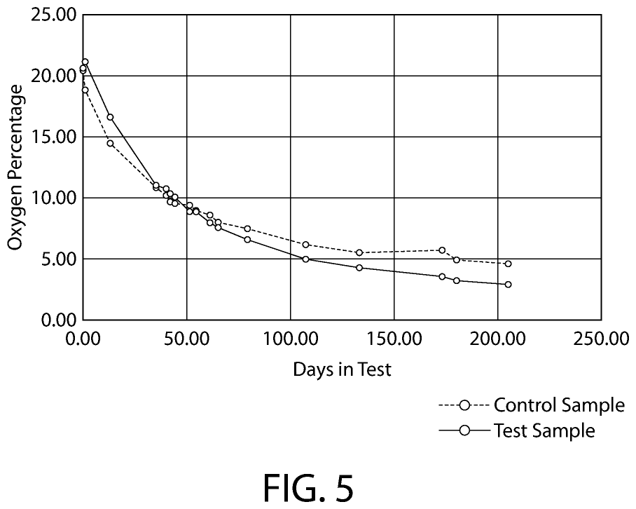

Samples of polymer film with a pre-ground green tea component were prepared and were compared to a control sample reference film. The control sample was commercially available oxygen-absorbing resin film made based on the teachings of U.S. Pat. No. 7,893,145, which did not have any tea component. Oxygen scavenging of the test samples was initiated by moisture from the filter paper, whereas oxygen scavenging by the control samples required a photo initiator, which was not needed for the tea-active film test samples. The tests as set forth in Example 1 were performed and analyzed to measure the concentration of oxygen in Mason jars or vials. Measurements were recorded and represented in FIG. 5. The results showed that the films prepared according to the invention with a tea component incorporated into the polymer in ground form functioned as well, or better, than the control sample oxygen scavenging resin film.

### Example 3

Ten samples of entrained three phase polymer film were prepared according to the invention consisting of polypropylene and polyethylene and 30% green tea by total weight of the composition. The green tea was ground to powder by a coffee grinder. The film was extruded by a typical extrusion process. Each sample of 2 g of film was placed into a 150 mL sealed Mason jar. The level of oxygen in the container was measured for approximately 330 days utilizing the OXYSENSE® oxygen measuring system of OxySense Inc., Devens, MA, USA. Samples 1 through 5 measured the oxygen scavenging properties of the film only. For samples 6 through 10, 1 mL of water was added to the container and the oxygen scavenging properties measured. The initial level of oxygen in the container was that of the typical or standard concentration of oxygen known in the atmosphere, to be between 20% to 22%, and is indicated as measured for each sample on day one. The level of oxygen in the container for each sample was measured approximately every day or every few days for approximately 330 days.

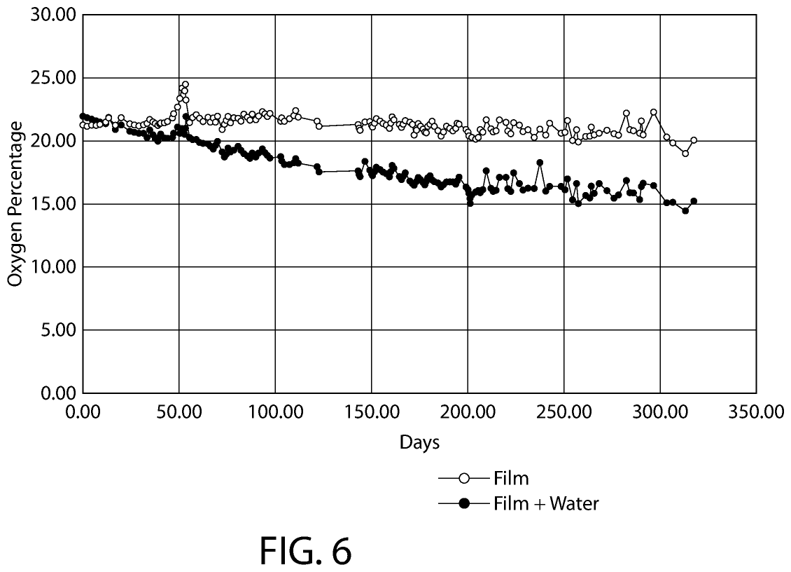

FIG. 6 demonstrates the results achieved. The recorded results indicate a clear decrease in the level of oxygen in the container. The concentrations of oxygen in the containers was maintained consistently at the decreased level, continuing to decrease slightly over the measured period of time.

The results also showed that the oxygen scavenging property of the tea active component was greatly enhanced within the container by the addition of water. This demonstrated that the moisture level in the container was instrumental in initiating the oxygen scavenging property of the tea to a greater or to its more complete capacity. As such, it is believed that the oxygen scavenging materials of the invention will be most useful for packaging and storage of products that contain some level of moisture in order to achieve the greatest oxygen scavenging effect within the container, or in packages where moisture is released or exuded by a product stored therein, or alternatively, where moisture may be added to the container from an alternate source or mechanism.

### Example 4

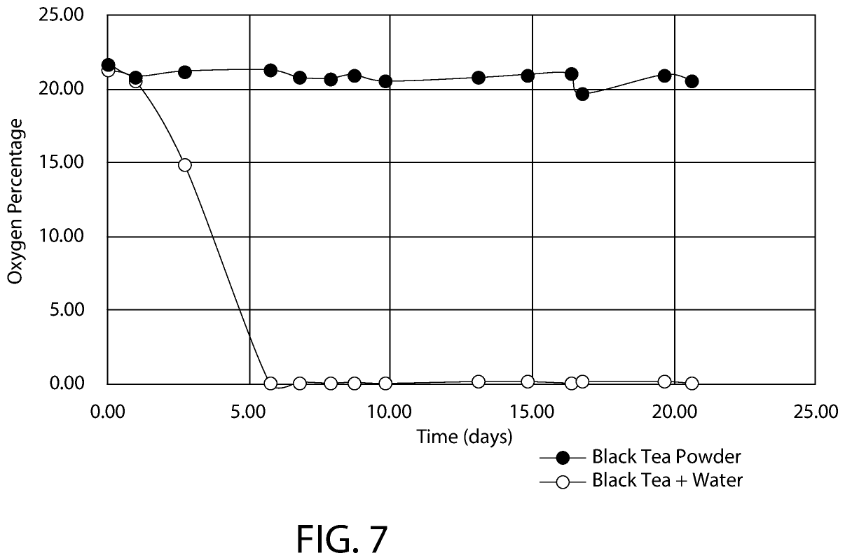

Samples of raw black tea were tested for their oxygen scavenging properties without incorporation into a polymer composition. Fresh black tea was prepared into black tea powder. Five samples were scattered into Mason jars in dry form; another 5 samples were scattered into Mason jars in a one to one ratio with water, 1 g of tea to 1 mL of water spritzed into the container. Oxygen concentration was measured in the Mason jars. After approximately 2 to 3 days, the initiation of formation of mold was observed in three of the samples. The remaining samples did not develop mold. The average calculated results for each group are presented on FIG. 7. It is theorized that with the three samples with mold, the mold may have played some part in oxygen uptake. Mold formation may present a problem with products used in accordance with the invention in this manner for oxygen control. Further investigation and development is needed to resolve this issue.

However, regardless of the samples with mold formation, the results of the remaining samples clearly demonstrate the oxygen scavenging activity of black tea initiated with the addition of water to the system for oxygen modification in a container.

While the invention has been described in detail and with reference to specific examples, it will be apparent to one skilled in the art that various changes and modifications can be made therein without departing from the spirit and scope of the invention and is further defined by the following claims.

1. An oxygen scavenging composition comprising an oxygen scavenging agent derived from the Camellia sinensis tea plant.

2. The oxygen scavenging composition of claim 1, wherein the oxygen scavenging agent is selected from the leaves, buds, stems or combinations thereof, of the Camellia sinensis tea plant.

3. The oxygen scavenging composition of claim 1, wherein the oxygen scavenging agent comprises at least one tea component selected from white tea, black tea, yellow tea, green tea, red tea, oolong tea and post-fermented tea.

4. The oxygen scavenging composition of claim 3, wherein the oxygen scavenging agent comprises green tea.

5. The oxygen scavenging composition of claim 3, wherein the oxygen scavenging agent comprises black tea.

6. A polymer composition comprising a base polymer and the oxygen scavenging composition of claim 1 dispersed in the base polymer.

7. The polymer composition of claim 6, wherein the polymer composition is produced by extrusion molding, injection molding, blow molding or vacuum molding.

8. The polymer composition of claim 7 wherein the polymer composition is formed into a film, a sheet, a disk, a pellet, a package, a container, a cover, a plug, a cap, a lid, an insert, a stopper, a cork, a gasket, a seal, a washer, or a liner.

9. The polymer composition of claim 6, wherein the base polymer is selected from polypropylene, polyethylene, polyisoprene, polyhexene, polybutadiene, polybutene, polysiloxane, polycarbonate, polyamide, ethylene-vinyl acetate copolymer, ethylene-methacrylate copolymer, poly(vinyl chloride), polystyrene, polyester, polyanhydride, polyacrylonitrile, polysulfone, polyacrylic ester, acrylic, polyurethane, polyacetal, a copolymer, or a combination thereof.

10. The polymer composition of claim 6, wherein the concentration of oxygen scavenging agent is in a range from 20% to 80%, optionally from 40% to 70%, optionally from 45% to 65%, optionally from 55% to 65% by weight with respect to the total weight of the polymer composition.

11. The polymer composition of claim 6, wherein the oxygen scavenging agent is added to the base polymer in an amount and/or concentration sufficient to function as an effective oxygen scavenger.

12. The polymer composition of claim 6, further comprising a channeling agent.

13. The polymer composition of claim 12, wherein the concentration of the channeling agent is in a range from 1% to 25%, optionally from 1% to 15%, optionally from 2% to 15%, optionally from 2% to 12%, optionally from 5% to 20%, optionally from 8% to 15%, optionally from 10% to 20%, optionally from 10% to 15%, or optionally from 10% to 12% by weight with respect to the total weight of the polymer composition.

14. The polymer composition of claim 12, wherein the channeling agent is selected from polyethylene glycol (PEG), ethylene-vinyl alcohol (EVOH), polyvinyl alcohol (PVOH), glycerin polyamine, polyurethane, polycarboxylic acid, propylene oxide polymerisate-monobutyl ether, propylene oxide polymerisate, ethylene vinyl acetate, nylon 6, nylon 66, or a combination thereof.

15. A composite material comprising the oxygen scavenging composition of claim 1 or the polymer composition of claim 6.

16. A packaging material comprising the oxygen scavenging composition of claim 1.

17. The packaging material of claim 16, wherein the material is selected from plastic, paper, glass, metal, synthetic resin and a combination thereof.

18. A container for controlling the concentration of oxygen in the container comprising leaves, stems or buds from the Camellia sinensis tea plant.

19. An oxygen-controlled container comprising the oxygen scavenging composition of claim 1 or the packaging material of claim 16.

20. The oxygen-controlled container of claim 18, wherein the container is used for retaining a food, herb, beverage, cosmetic, pharmaceutical, medical product, tobacco, or cannabis.

21. The oxygen-controlled container of claim 18, wherein the container is used for retaining electronic or military products.

22. A method of reducing the concentration of oxygen in a sealed container, the method comprising the step of enclosing in the container an oxygen scavenging composition comprising an oxygen scavenging agent derived from the Camellia sinensis tea plant in an amount sufficient to reduce the concentration of oxygen in the container.

23. The method of claim 22, wherein the oxygen scavenging agent comprises leaves, buds, stems or a combination thereof from the Camellia sinensis tea plant.

24. The method of claim 22, wherein the oxygen scavenging composition is provided to the sealed container in the form of a sachet or an absorbent packet.

25. The method of claim 22, wherein the oxygen scavenging composition is provided within the headspace of the sealed container.

26. The method of claim 22, further comprising the step of providing an amount of liquid or moisture to the sealed container sufficient to cause the oxygen scavenging composition to scavenge oxygen.

27. The method of claim 22, further comprising enclosing an oxygen sensitive product within the sealed container, wherein the oxygen scavenging composition inhibits oxygen-initiated degradation of the oxygen sensitive product.

28. The method of claim 24, wherein the oxygen scavenging composition inhibits oxygen-initiated degradation of the oxygen sensitive product without physically contacting the oxygen sensitive product.
